(19) United States
(12) Patent Application Publication
(10) Pub. No.: US 2015/0219406 A1
(43) Pub. Date: Aug. 6, 2015

(54) Heat Dissipation Device

(71) Applicant: Asia Vital Components Co., Ltd., New Taipei City (TW)

(72) Inventors: Chih-Yeh Lin, New Taipei City (TW); Chih-Ming Chen, New Taipei City (TW)

(73) Assignee: Asia Vital Components Co., Ltd., New Taipei City (TW)

(21) Appl. No.: 14/169,426

(22) Filed: Jan. 31, 2014

(51) Int. Cl. F28F 3/02; G06F 1/20

(52) U.S. Cl. CPC F28F 3/02; G06F 1/203

(57) ABSTRACT

A heat dissipation device includes a main body and a radiation heat dissipation layer. The main body has a first board body and a second board body. The first and second board bodies are correspondingly mated with each other to define a receiving space. At least one capillary structure and a working fluid are disposed in the receiving space. The radiation heat dissipation layer is formed on one face of the second board body, which face is distal from the first board body. The heat dissipation device is disposed in a mobile device to provide a very good heat dissipation effect for the closed space of the mobile device by way of natural convection and radiation. Therefore, the heat dissipation performance of the entire mobile device is greatly enhanced.

### BACKGROUND OF THE INVENTION

1. Field of the Invention

The present invention relates generally to a heat dissipation device, and more particularly to a heat dissipation device, which is able to provide a very good heat dissipation effect by way of natural radiation so as to enhance the heat dissipation performance of a mobile device.

2. Description of the Related Art

Currently, there are various mobile devices such as thin-type notebook, tablet and intelligent mobile phone. The internal calculation execution units of the mobile devices have higher and higher operation speed. As a result, the heat generated by these units is greatly increased. In consideration of convenient carriage, these mobile devices have become thinner and thinner. Also, in order to prevent alien article and moisture from entering the interior of the mobile device, the mobile device is generally simply formed with earphone port or connector port without any other opening in communication with ambient air. Therefore, convection can hardly take place between the internal air of the mobile device and the ambient air. Due to the inherent factor of thinned design, the heat generated by the internal calculation execution units and battery of the mobile device can be hardly quickly dissipated outward. Moreover, the internal space of the mobile device is a closed space so that convection is very hard to take place. Under such circumstance, the heat can be hardly dissipated. As a result, the heat will accumulate within the mobile device. This will seriously deteriorate the working efficiency of the mobile device or even lead to thermal crash of the mobile device.

Furthermore, in order to solve the above problems, some manufacturers arrange passive heat dissipation elements inside the mobile device, such as heat plate, vapor chamber and heat sink to dissipate the heat. However, still due to the thinned design of the mobile device, the internal space of the mobile device is so narrow that the heat dissipation elements arranged in the space are limited to have an ultrathin thickness for arrangement in the narrow internal space. Due to the limitation of size and thickness, the internal capillary structures and vapor passages of the heat plate and vapor chamber must be very thin. Under such circumstance, as a whole, the heat conduction efficiency of the heat plate and vapor chamber is inevitably detracted. As a result, the heat dissipation performance can be hardly enhanced. In addition, the heat plate and vapor chamber mainly serve to conduct heat, not dissipate heat. In case that the power of the internal calculation unit of the mobile device is too high and no airflow convection takes place inside the mobile device, the conventional heat plate and vapor chamber will be unable to effectively dissipate the heat generated by the calculation unit. This will lead to accumulation of heat of the heat plate and vapor chamber. Therefore, it has become a critical issue in this field how to arrange effective heat dissipation elements in the narrow closed space of the mobile device to effectively dissipate the heat.

### SUMMARY OF THE INVENTION

It is therefore a primary object of the present invention to provide a heat dissipation device, which is able to provide a very good heat dissipation effect by way of natural radiation so as to enhance the heat dissipation performance. To achieve the above and other objects, the heat dissipation device of the present invention includes a main body and a radiation heat dissipation layer.

The main body has a first board body and a second board body. The first and second board bodies are correspondingly mated with each other to define a receiving space. At least one capillary structure and a working fluid are disposed in the receiving space. The radiation heat dissipation layer is formed on one face of the second board body, which face is distal from the first board body.

The radiation heat dissipation layer is disposed on one face of the second board body of the main body. The heat dissipation device is disposed in a closed space to provide a very good heat dissipation effect by way of natural convection and radiation. Therefore, as a whole, the heat dissipation performance of the heat dissipation device is greatly enhanced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of a first embodiment of the heat dissipation device of the present invention;

FIG. 2 is a sectional assembled view of the first embodiment of the heat dissipation device of the present invention;

FIG. 3 is a sectional assembled view of a second embodiment of the heat dissipation device of the present invention; and

FIG. 4 is another sectional assembled view of the second embodiment of the heat dissipation device of the present invention.

### DETAILED DESCRIPTION OF THE PREFERRED EMBODIMENTS

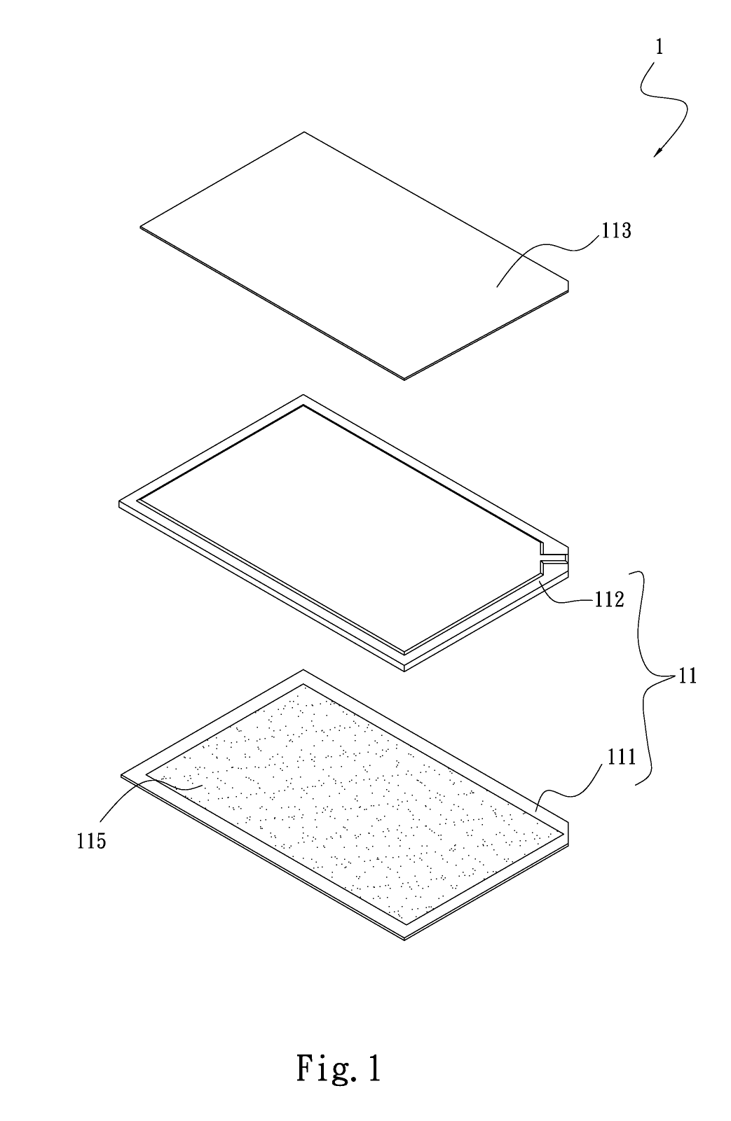

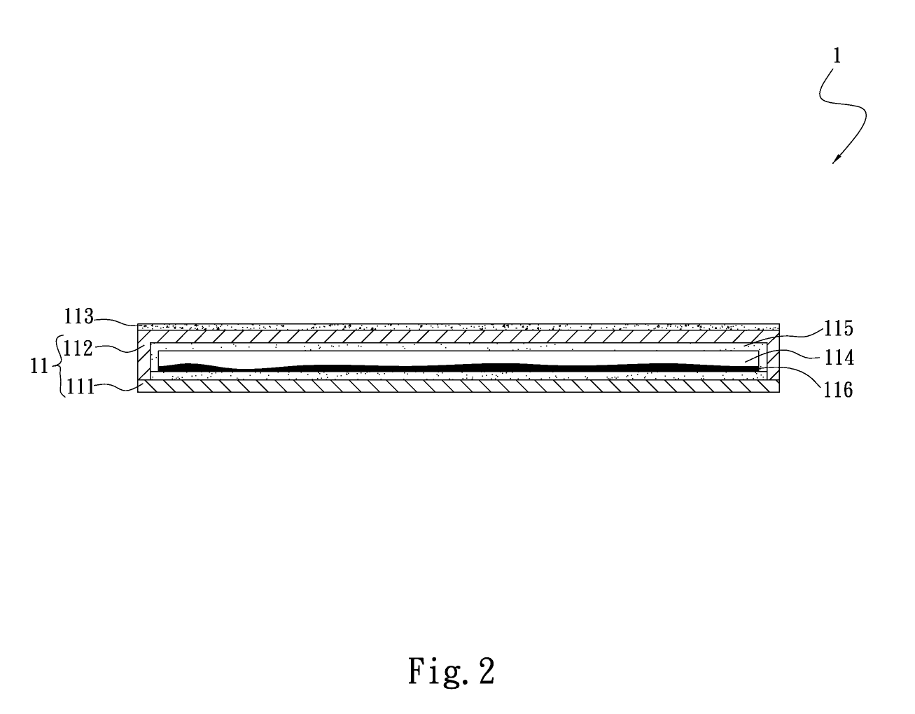

Please refer to FIGS. 1 and 2. FIG. 1 is a perspective exploded view of a first embodiment of the heat dissipation device of the present invention. FIG. 2 is a sectional assembled view of the first embodiment of the heat dissipation device of the present invention. According to the first embodiment, the heat dissipation device 1 of the present invention includes a main body 11 and a radiation heat dissipation layer 113. The main body 11 has a first board body 111 and a second board body 112. The first and second board bodies 111, 112 are correspondingly mated with each other to define a receiving space 114. At least one capillary structure 115 and a working fluid 116 are disposed in the receiving space 114.

The radiation heat dissipation layer 113 is formed on one face of the second board body 112, which face is distal from the first board body 111. That is, the radiation heat dissipation layer 113 is formed on a condensation side of the second board body 112.

The first board body 111 is a board body made of copper material. The second board body 112 is a board body made of aluminum material or ceramic material. In this embodiment, the second board body 112 is, but not limited to, made of aluminum material for illustration purposes. The first and second board bodies 111, 112 are attached to each other by means of adhesive bonding or medium-free diffusion bonding.

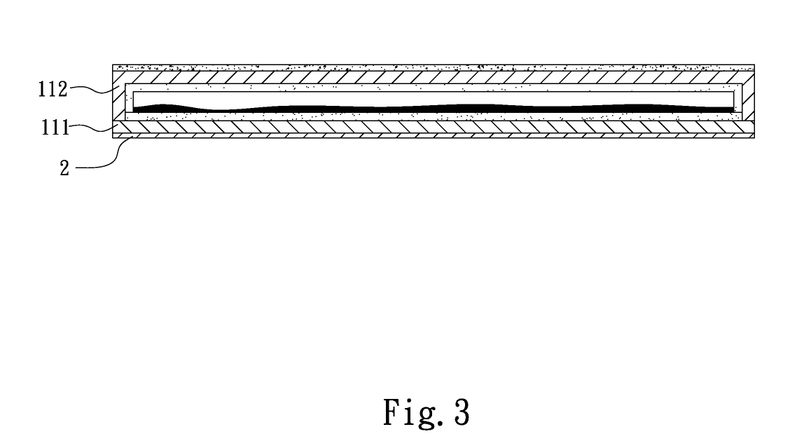

Please now refer to FIG. 3, which is a sectional assembled view of a second embodiment of the heat dissipation device of the present invention. The second embodiment is partially identical to the first embodiment in structure and thus will not be repeatedly described hereinafter. The second embodiment is different from the first embodiment in that both the first and second board bodies 111, 112 are selectively made of aluminum material or ceramic material. A copper coating 2 is coated on one face of the first board body 111, which face is an outer face in contact with a heat source.

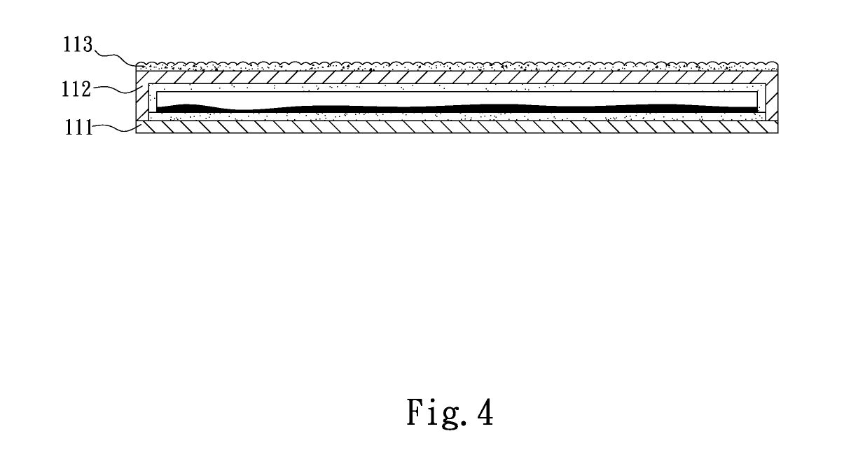

In the first and second embodiments, the radiation heat dissipation layer 113 is selected from a group consisting of porous structure, nanostructure body, porous ceramic structure, porous graphite structure, high-radiation ceramic structure and high-hardness ceramic structure. Alternatively, the radiation heat dissipation layer 113 can be formed with recessed/raised structures by means of shot peening (as shown in FIG. 4).

The radiation heat dissipation layer 113 of porous structure is formed on one face of the second board body by a means selected from a group consisting of Micro Arc Oxidation (MAO), Plasma Electrolytic Oxidation (PEO), Anodic Spark Deposition (ASD) and Anodic Oxidation by Spark Deposition (ANOF).

The radiation heat dissipation layer 113 has black color, sub-black color or dark color.

The heat dissipation device of the present invention can provide higher heat dissipation effect by way of natural radiation.

In the heat dissipation device of the present invention, the copper coating is partially attached to or coated on one face of the first board body 111 made of copper material so as to enhance the heat absorption efficiency of the main body 11. The black radiating heat dissipation layer 113 is disposed on the second board body 112 to increase the heat dissipation contact area thereof so as to promote the heat radiation dissipation efficiency.

The heat dissipation device of the present invention is, but not limited to, a vapor chamber for illustration purposes. Alternatively, the heat dissipation device of the present invention can be a heat plate or a heat pipe.

The present invention mainly dissipates the heat by way of heat radiation. Heat conduction and convection both necessitate a medium for transferring the heat, while heat radiation can directly transfer the heat without any medium. Accordingly, even in a tiny closed space, the heat can be still transferred to the case of the mobile device for heat exchange between the case and the exterior.

Heat radiation means that the heat is transferred in the form of electromagnetic wave at light speed without any medium. An object can continuously radiate heat and absorb heat radiation from outer side. The ability of radiating heat of an object is related to the surface temperature, color and roughness of the object. According to the relevant application principles, the present invention employs the radiation heat dissipation layer to increase the surface heat dissipation area and promote the natural heat dissipation efficiency. The surface heat radiation intensity of the object is not only related to the temperature, but also related to the properties of the surface. For example, an object with black surface is easier to absorb heat radiation and also easier to radiate heat. Accordingly, the radiation heat dissipation layer of the present invention has black color or the surface of the radiation heat dissipation layer has black color to further enhance the heat radiation efficiency.

The present invention has been described with the above embodiments thereof and it is understood that many changes and modifications in the above embodiments can be carried out without departing from the scope and the spirit of the invention that is intended to be limited only by the appended claims.

What is claimed is:

1. A heat dissipation device comprising
a main body having a first board body and a second board body, the first and second board bodies being correspondingly mated with each other to define a receiving space, at least one capillary structure and a working fluid being disposed in the receiving space; and
a radiation heat dissipation layer formed on one face of the second board body, which face is distal from the first board body.

2. The heat dissipation device as claimed in claim 1, wherein the first board body is a board body made of copper material, while the second board body is a board body made of aluminum material.

3. The heat dissipation device as claimed in claim 1, wherein both the first and second board bodies are made of aluminum material and a copper coating is coated on one face of the first board body.

4. The heat dissipation device as claimed in claim 1, wherein the first board body is a board body made of copper material, while the second board body is a board body made of ceramic material.

5. The heat dissipation device as claimed in claim 1, wherein both the first and second board bodies are made of ceramic material and a copper coating is coated on one face of the first board body.

6. The heat dissipation device as claimed in claim 1, wherein the radiation heat dissipation layer is selected from a group consisting of porous structure and nanostructure body.

7. The heat dissipation device as claimed in claim 1, wherein the radiation heat dissipation layer is a porous structure formed on one face of the second board body by a means selected from a group consisting of Micro Arc Oxidation (MAO), Plasma Electrolytic Oxidation (PEO), Anodic Spark Deposition (ASD) and Anodic Oxidation by Spark Deposition (ANOF).

8. The heat dissipation device as claimed in claim 1, wherein the radiation heat dissipation layer is a recessed/raised structure formed by means of shot peening.

9. The heat dissipation device as claimed in claim 1, wherein the radiation heat dissipation layer is selected from a group consisting of porous ceramic structure and porous graphite structure.

10. The heat dissipation device as claimed in claim 1, wherein the radiation heat dissipation layer has black color, sub-black color or dark color.

11. The heat dissipation device as claimed in claim 2, wherein the first and second board bodies are attached to each other by means of adhesive bonding or medium-free diffusion bonding.

12. The heat dissipation device as claimed in claim 1, wherein the radiation heat dissipation layer is selected from a group consisting of high-radiation ceramic structure and high-hardness ceramic structure.

13. The heat dissipation device as claimed in claim 2, wherein the radiation heat dissipation layer has black color, sub-black color or dark color.

14. The heat dissipation device as claimed in claim 3, wherein the radiation heat dissipation layer has black color, sub-black color or dark color.

15. The heat dissipation device as claimed in claim 4, wherein the radiation heat dissipation layer has black color, sub-black color or dark color.

16. The heat dissipation device as claimed in claim 5, wherein the radiation heat dissipation layer has black color, sub-black color or dark color.

17. The heat dissipation device as claimed in claim 6, wherein the radiation heat dissipation layer has black color, sub-black color or dark color.

18. The heat dissipation device as claimed in claim 7, wherein the radiation heat dissipation layer has black color, sub-black color or dark color.

19. The heat dissipation device as claimed in claim 8, wherein the radiation heat dissipation layer has black color, sub-black color or dark color.

20. The heat dissipation device as claimed in claim 9, wherein the radiation heat dissipation layer has black color, sub-black color or dark color.
